(19) United States
(12) Patent Application Publication
(10) Pub. No.: US 2017/0129114 A1
(43) Pub. Date: May 11, 2017

(54) SHAVER

(71) Applicant: DORCO CO., LTD., YONGIN-SI (KR)

(72) Inventors: Young Ho PARK, GUNPO-SI (KR); Byung Sun AN, ANSAN-SI (KR)

(21) Appl. No.: 15/416,170

(22) Filed: Jan. 26, 2017

Related U.S. Application Data
(63) Continuation of application No. 12/306,626, filed on Dec. 24, 2008, now Pat. No. 9,604,373.

(30) Foreign Application Priority Data
Jun. 29, 2006 (KR) 10-2006-0059004
Jun. 27, 2007 (KR) PCT/KR2007/003110

(51) Int. Cl. B26B 21/22; B26B 21/52; B26B 21/40

(52) U.S. Cl. CPC B26B 21/225; B26B 21/4012; B26B 21/521; B26B 21/4068

(57) ABSTRACT

Provided is a shaver including a cartridge and a handle body. The cartridge includes a cartridge body formed in a rectangular frame shape; a plurality of blades installed in the cartridge body in the side-to-side direction of the cartridge body, each of the blades having a front portion bent downward; pair of side fixation slots formed on left and right frames of the cartridge body, respectively, so as to fix the left and right ends of each blade; a supporter connecting upper and lower frames of the cartridge body; and an inside fixation slot formed on the supporter so as to fix a portion of each blade. The handle body is coupled to the cartridge body.

### TECHNICAL FIELD

The present invention relates to a shaver, and more specifically, to a shaver of which the washability, the shaving performance, the stability, and the operating performance can be enhanced.

### BACKGROUND ART

In general, a conventional shaver includes a cartridge, on which a plurality of blades for cutting hair such as beard are mounted, and a handle assembly which is held by a user's hand during shaving.

In a state where the cartridge and the handle assembly are coupled to each other, the user holds the handle assembly by hand and closely contacts the cartridge onto the user's skin. Then, the user shaves beard through the blades.

In order to enhance shaving efficiency, the plurality of blades are mounted on the cartridge at a variable distance from each other.

However, when the conventional shaver is used for a long time, sludge composed of beard and other foreign substance is clogged between the blades so as not to be discharged. Therefore, the shaving performance of the shaver is degraded, and the sludge is difficult to wash away.

Further, as the sludge is clogged, various bacterium proliferate, which are harmful to body.

In addition, the conventional shaver has such a structure that both ends of each blade are fixed to the cartridge. Therefore, since a force for fixing the blade is weak, the stability of the shaver decreases.

Furthermore, the cartridge and the handle assembly of the shaver are coupled to each other through a hinge method. In this structure, the swing operation of the cartridge is simply supported by a hinge. Therefore, the surface contact force of the cartridge is so weak that the shaving performance and the operating performance of the shaver are degraded.

### DISCLOSURE OF INVENTION

### Technical Problem

The present invention provides a shaver which smoothly discharges sludge generated during shaving such that the washability thereof is enhanced. In the shaver, a force for fixing blades is enhanced so as to improve the shaving performance thereof, and a swing operation of a cartridge is elastically supported so as to enhance the stability and the operating performance thereof.

### Technical Solution

According to an aspect of the invention, a shaver comprises a cartridge and a handle body. The cartridge includes a cartridge body formed in a rectangular frame shape; a plurality of blades installed in the cartridge body in the side-to-side direction of the cartridge body, each of the blades having a front portion bent downward; pair of side fixation slots formed on left and right frames of the cartridge body, respectively, so as to fix the left and right ends of each blade; a supporter connecting upper and lower frames of the cartridge body; and an inside fixation slot formed on the supporter so as to fix a portion of each blade. The handle body is coupled to the cartridge body.

The inside fixation slot may be formed in a wave shape along the side-to-side direction of the cartridge body.

The plurality of blades may be installed at a variable distance from each other along the top-to-bottom direction of the cartridge body, and the side fixation slots and the inside fixation slot may be formed to correspond to the number of the installed blades and the distance between the installed blades.

The cartridge body and the handle body may be coupled to each other through front hinge mounting.

The cartridge body may have a hinge portion formed on either end of the lower frame thereof, the hinge portion having a hinge groove, and the handle body may have a hinge protrusion formed on either upper end thereof, the hinge protrusion being coupled to the hinge groove.

The handle body may have an elastic portion projecting from an upper portion thereof, the elastic portion being closely contacted with the rear surface of the supporter when the handle body is coupled to the cartridge body, and a swing operation of the cartridge body may be elastically performed by the elastic force of the elastic portion.

The rear surface of the supporter may be convexly curved.

### Advantageous Effects

The effects of the shaver according to the invention will be described.

Firstly, since the front portions of the blades are bent downwardly and the cartridge body is formed in a rectangular frame shape, sludge generated during shaving is smoothly discharged to the outside. Therefore, it is possible to improve washability.

Secondly, a portion of each blade is fixed by the inside fixation slot such that the force for fixing the blade is enhanced. Therefore, it is possible to improve the stability and shaving performance of the shaver.

Thirdly, since the swing operation of the cartridge is elastically supported, the contact force of the blade with respect to the skin during shaving is enhanced.

Therefore, it is possible to improve the shaving performance and operating performance of the shaver.

### BRIEF DESCRIPTION OF THE DRAWINGS

FIG. 1 is a perspective view of a shaver according to the present invention.

FIG. 2 is a perspective view of a cartridge of the shaver according to the invention.

FIG. 3 is a front view of the cartridge of the shaver according too the invention.

FIG. 4 is a cross-sectional view taken along line I-I of FIG. 3.

FIG. 5 is a side view of blades of the shaver according to the invention.

FIG. 6 is a rear view of the shaver according to the invention, showing a state where a cartridge and a handle assembly are coupled to each other.

FIG. 7 is a cross-sectional view taken along line II-II of FIG. 6.

FIG. 8 is a side view illustrating an operating structure of the shaver according to the invention.

### BEST MODE FOR CARRYING OUT THE INVENTION

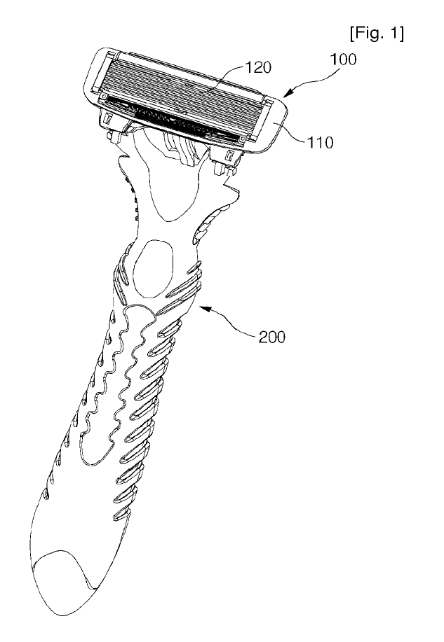

Hereinafter, a shaver according to an embodiment of the invention will be described with reference to FIGS. 1 to 8.

As shown in FIG. 1, the shaver according to the invention includes a cartridge 100 having a plurality of blades 120 mounted thereon and a handle assembly 200 coupled to the cartridge 100.

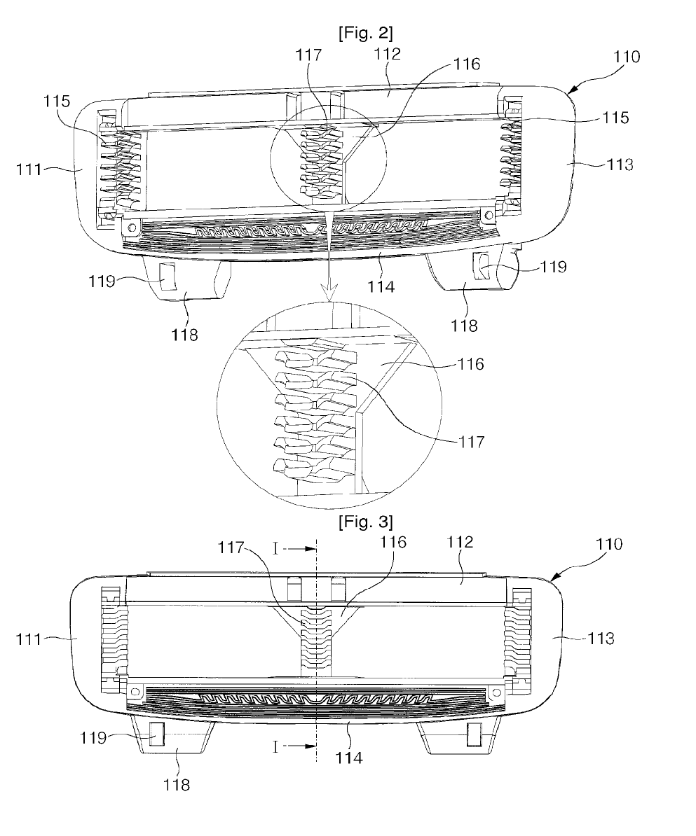

As shown in FIG. 2, the cartridge 100 includes a cartridge body 110 formed in a rectangular frame shape, the plurality of blades 120 (refer to FIG. 1) installed in the cartridge body 110 along the side-to-side direction, a pair of side fixation slots 115 which are formed on left and right frames 111 and 113 of the cartridge body 110, respectively, so as to fix the left and right ends of each blade 120, a supporter 116 which connects upper and lower frames 112 and 114 of the cartridge body 110, an inside fixation slot 117 which is formed on the support 116 so as to fix a portion of each blade 120, and a pair of hinge portions 118 having a hinge groove 119 coupled to the handle assembly 200 through front hinge mounting.

As shown in FIG. 3, the inside fixation slot 117 is formed in a wave shape along the side-to-side direction of the cartridge body 110.

In this case, the inside fixation slot 117 has such a side-to-side width as to reliably fix the blade 120. Preferably, the inside fixation slot 117 has such a width that sludge, such as beard cut by the blades 120 and other foreign substance, can be smoothly discharged. For example, the inside fixation slot 117 may be formed to have a side-to-side width of about 2.5 mm.

The side fixing slots 115 are formed in a shape corresponding to the inside fixation slot 117. In this case, since the side fixation slots 115 are formed in the left and right frames 111 and 113 of the cartridge body 110, respectively, it is preferable that the width of the side fixation slots 115 is set to be smaller than that of the inside fixation slot 117.

In this embodiment, the inside fixation slot 117 is formed in substantially a central position between the side fixation slots 115. However, a plurality of inside fixation slots 117 may be installed between the side fixation slots 115 so as to fix the blades 120 more reliably. In this case, it can be expected that a plurality of supporters 116 should be provided for the formation of the plurality of inside fixation slots 117.

Further, the inside fixation slot 117 should be spaced at a proper distance from the side fixation slots 115, respectively, in order to fix the blades 120 more reliably.

Preferably, as the thickness of the blade 120 decreases, the distance between the inside fixation slot 117 and the side fixation slots 115 is narrowed. For example, when the thickness of the blade 120 is set in the range of 0.075 to 0.15 mm, the distance between the inside fixation slot 117 and the side fixation slot 115 is preferably set to about 15 mm.

Accordingly, the left and right ends of each blade 120 are fixed by the side fixation slots 115, and a portion of the blade 120 is fixed by the inside fixation slot 117. Therefore, a force for fixing the blade 120 is enhanced, thereby improving stability and shaving performance during shaving.

As shown in FIG. 4, the plurality of blades 120 are installed at a variable distance from each other along the top-to-bottom direction of the cartridge body 110. That is, the plurality of blades 120 may be installed at even distances or different distances from each other along the top-to-bottom direction of the cartridge body 110.

In this case, the inside fixation slot 117 is formed to correspond to the number of installed blades 120 and the distance between the installed blades 120. Further, the side fixation slots 115 are also formed to correspond to the number of installed blades 120 and the distance between the installed blades 120.

That is, when the plurality of blades 120 are installed in the cartridge body 110, an accurate number of blades 120 can be installed at a variable distance from each other through the side fixation slots 115 and the inside fixation slot 117.

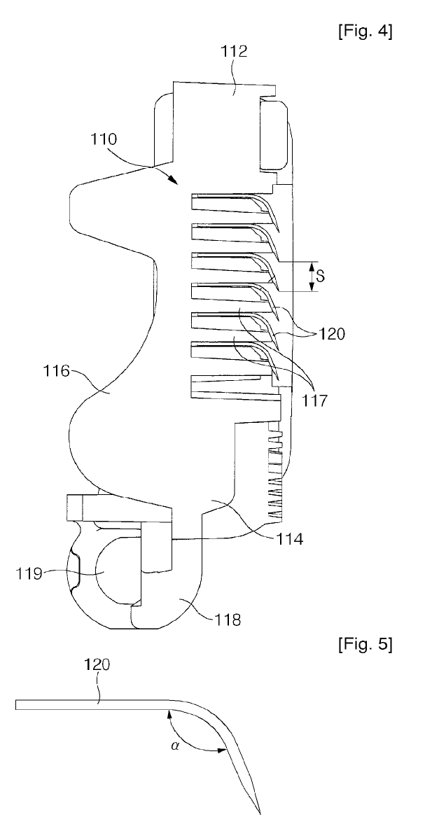

Meanwhile, as shown in FIGS. 4 and 5, the front portion of each blade 120 is bent downward from the rear portion thereof.

The blade 120 can be manufactured in order of punching, heat-treatment, grinding, coating, and bending.

The blade 120 is formed to have a proper length and thickness. For example, the overall length of the blade 120 may be set in the range of 3.0 to 4.0 mm, and the thickness thereof may be set in the range of 0.075 to 0.15 mm.

The front portion of the blade 120 is bent downward with a proper length and at a proper angle. Preferably, the length of the bent portion of the blade 120 ranges from 0.6 to 1.0 mm, and the front portion forms an angle a with the rear portion, which ranges from 108 to 115 degrees.

When the plurality of blades 120 are installed for smooth shaving, the front portions of the blades 120 are integrally bent downward from the rear portions thereof such that distances S between the respective blades 120 can be freely set to various values.

That is, as the front portions of the blades 120 are integrally bent from the rear portions thereof, sludge generated during shaving flows along continuous surfaces of the blades 120. Therefore, when the distance S between the blades 120 is set to be small, the sludge can be smoothly discharged, while a large amount of beard is easily cut. For example, the distance S between the blades 120 can be freely set in the range of 0.7 to 1.5 mm.

At this time, as the front portions of the blades 120 are bent downward, the distance between the front portions of the blades 120 is set to be smaller than the distance between the rear portions thereof.

Therefore, sludge composed of beard cut by the blades 120 and other foreign substance smoothly flows from the front portions to the rear portions of the blades 120. Therefore, the washability of the shaver can be further enhanced.

In the shaver according to the invention, an accurate number of blades 120 are installed at a variable distance in the cartridge body 110 such that a force for cutting beard during shaving can be accurately distributed onto the respective blades 120, thereby enhancing the cutting force and lifespan of the blades 120.

Meanwhile, the inside fixation slot 117 may have an inclined surface formed on the front portion thereof such that the front portion of each blade 120 is smoothly supported in accordance with the bending angle of the blade 120. The inclined surface of the inside fixation slot 117 is closely contacted with one surface of the front portion of the blade 120.

Preferably, the rear portion of the blade 120 is contacted as closely as possible to the rear portion of the inside fixation slot 117 such that the blade 120 is reliably supported.

Therefore, the inside fixation slot 117 reliably supports the rear portion and the downwardly-bent front portion of the blade 120 such that the force for fixing the blade 120 is enhanced. Accordingly, it is possible to enhance the stability and reliability of the shaver.

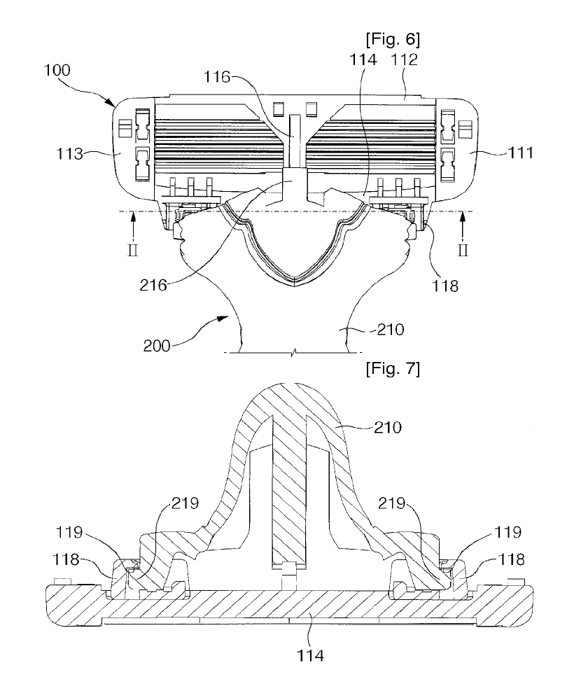

As shown in FIG. 6, the handle assembly 200 includes the handle body 210 coupled to the cartridge body 110.

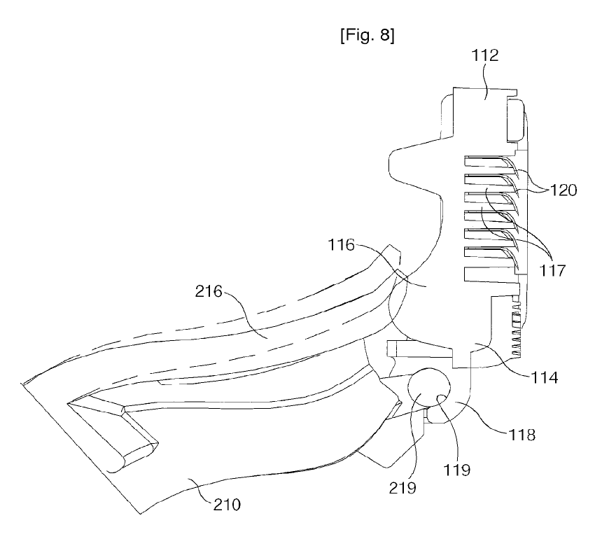

As shown in FIG. 7, the handle body 210 has a pair of hinge protrusions 210 formed in both upper ends thereof. The hinge protrusions 210 are coupled to the hinge grooves 119 formed in the hinge portions 118 of the cartridge body 110 such that the handle body 210 is assembled into the cartridge body 110 through the front hinge mounting.

In the shaver according to the invention, the hinge portions 118 having the hinge groove 119 are formed in both ends of the lower frame 114 of the cartridge body 110, and the hinge protrusions 219 coupled to the hinge grooves 119 are formed in both upper ends of the handle body 210. Therefore, the swing center of the cartridge 100 is formed in the lower end of the cartridge 100 such that the swing range of the cartridge 100 increases. Accordingly, shaving can be easily performed on a curved skin.

As shown in FIG. 6, the handle body 210 has an elastic portion 216 projecting from an upper portion thereof. The elastic portion 216 is closely contacted with the rear surface of the supporter 116, when the handle body 210 is coupled to the cartridge body 110.

That is, a swing operation of the cartridge body 110 is elastically supported by the elastic force of the elastic portion 216. Therefore, the contact force of the cartridge 100 with respect to the skin is enhanced, thereby improving the shaving performance of the shaver.

As shown in FIG. 8, it is preferable that the rear surface of the supporter 116 is convexly curved.

That is, the convex rear surface of the supporter 116 applies a larger compression force to the elastic portion 216 of the handle body 210, when the cartridge 100 is swung. Then, a restoring force of the elastic portion 216 with respect to the compression force is increased, so that the contact force of the cartridge 100 with respect to the skin can be further enhanced.

In addition, as the rear surface of the supporter 116 is convexly curved, a frictional force between the elastic portion 216 and the rear surface of the supporter 116 is minimized. Then, the swing operation of the cartridge 100 can be more smoothly performed, so that the operating performance of the shaver can be enhanced.

### INDUSTRIAL APPLICABILITY

According to the shaver of the invention, sludge generated during shaving is smoothly discharged so that the washability of the shaver can be enhanced. The blades are reliably fixed so as to improve the shaving performance. Further, the swing operation of the cartridge is elastically supported, so that the stability and operating performance of the shaver can be enhanced.

1. A shaver comprising:
a cartridge including:
a cartridge body formed in a rectangular frame shape;
a plurality of blades installed in the cartridge body in the side-to-side direction of the cartridge body, each of the blades having a front portion bent downward;
a pair of side fixation slots formed on left and right frames of the cartridge body, respectively, so as to fix the left and right ends of each blade;
a supporter connecting upper and lower frames of the cartridge body; and
an inside fixation slot formed on the supporter so as to fix a portion of each blade, and
a handle body coupled to the cartridge body.

2. The shaver according to claim 1, wherein the inside fixation slot is formed in a wave shape along the side-to-side direction of the cartridge body.

3. The shaver according to claim 1, wherein the plurality of blades are installed at a variable distance from each other along the top-to-bottom direction of the cartridge body, and the side fixation slots and the inside fixation slot are formed to correspond to the number of the installed blades and the distance between the installed blades.

4. The shaver according to claim 1, wherein the cartridge body and the handle body are coupled to each other through front hinge mounting.

5. The shaver according to claim 4, wherein the cartridge body has a hinge portion formed on either end of the lower frame thereof, the hinge portion having a hinge groove, and the handle body has a hinge protrusion formed on either upper end thereof, the hinge protrusion being coupled to the hinge groove.

6. The shaver according to claim 1, wherein the handle body has an elastic portion projecting from an upper portion thereof, the elastic portion being closely contacted with the rear surface of the supporter when the handle body is coupled to the cartridge body, and a swing operation of the cartridge body is elastically performed by the elastic force of the elastic portion.

7. The shaver according to claim 6, wherein the rear surface of the supporter is convexly curved.
